(19) United States
(12) Patent Application Publication
(10) Pub. No.: US 2004/0161124 A1
(43) Pub. Date: Aug. 19, 2004

(54) Speaker device

(75) Inventors: Hayato Otomo, Yamagata (JP); Kenji Takahashi, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 10/680,784

(22) Filed: Oct. 8, 2003

(30) Foreign Application Priority Data
Feb. 14, 2003 (JP) P2003-036380

(51) Int. Cl. H04R 25/00

(52) U.S. Cl. 381/162

(57) ABSTRACT

A speaker device 10 includes a first vibration system 12 that is connected to a diaphragm 24, and a second vibration system 13 that is driven in a contrary direction to the first vibration system 12. A magnetic circuit 11 is composed of a first plate 15, a second plate 18, a yoke 16, and a magnet 17, in which the first vibration system 12 has a first voice coil 20 connected to the diaphragm 24 and a frame 25, and the second vibration system 13 has a second voice coil 21 connected via a second damper 36 to the frame 25.

### CROSS REFERENCE OF RELATED APPLICATION

This application is based on and claims priority under 35 U.S.C. § 119 with respect to Japanese Patent Application No. 2003-36380 filed on Feb. 14, 2003, the entire content of which is incorporated herein by reference.

### BACKGROUND OF THE INVENTION

1. Field of the Invention

The present invention relates to a speaker device, and more particularly to a speaker device having a vibration system that vibrates with a magnetic circuit.

2. Description of the Related Art

As a speaker device having a vibration system vibrating with a magnetic circuit that is used for home or mounted on the vehicle, a dome type speaker device using a moving coil is well known. In such speaker device, a voice coil is vibrated together with a diaphragm by supplying an electromagnetic drive to the voice coil within the magnetic circuit, radiating an acoustic energy.

FIG. 1 is a view showing a constitution example of a conventional speaker device, with its cross section being shown on the right side of the A-A line.

The conventional speaker device 100 is provided with a magnetic circuit 104 having a yoke 101, a plate 102, and a magnet 103, as shown in FIG. 1.

A magnetic gap G is formed between the yoke 101 and the plate 102. The magnet 103 is disposed in a state where it is sandwiched between the plate 102 and the yoke 101.

A vibration system 114 of the speaker device 100 has a voice coil 105 inserted in the magnetic gap G, in which the voice coil 105 is connected to a diaphragm 106 and a frame 111. More specifically, an upper end portion of a voice coil bobbin 107 of barrel shape around which the voice coil 105 is wound is connected to the diaphragm 106, with an edge 106a of the diaphragm 106 being bonded with the frame 111.

The voice coil bobbin 107 is fitted with a damper 112, in which an outer frame 112a of the damper 112 is secured to the frame 111. The voice coil 105 is electrically connected to an input terminal via a gilt wire 113.

In the above speaker device 100, the frame 111 vibrates as a reaction when the vibration system 114 is driven, and its vibration may be possibly propagated to a housing to which the speaker device 100 is mounted.

In this manner, if unnecessary vibration is propagated to the housing, the housing itself may resonate to generate a vibration sound or a so-called beep at a joint or contact portion of the housing, resulting in a problem that the speaker device is degraded in the sound quality.

Moreover, in the speaker device contained within an electronic apparatus such as a television or a personal computer, there is a possibility that the electronic parts packaged on the electronic apparatus may cause a malfunction or operation failure due to unnecessary vibration propagated to the housing.

For example, a flash phenomenon occurs on a liquid crystal panel in a liquid crystal display unit.

### SUMMARY OF THE INVENTION

In view of the above-mentioned problems, it is an object of the invention to provide a speaker device in which there is no degradation in the sound quality due to unnecessary vibration propagated to the housing by solving a problem associated with the prior art, and a malfunction or operation failure of electronic parts due to this vibration is prevented.

To solve the above object, according to the invention, there is provided a speaker device comprising a first vibration system that is driven by a magnetic circuit, and a second vibration system that is driven in a contrary direction to the first vibration system by the magnetic circuit.

### BRIEF DESCRIPTION OF THE DRAWINGS

These and other objects and advantages of this invention will become more fully apparent from the following detailed description taken with the accompanying drawings in which:

FIG. 1 is a cross-sectional view showing a conventional speaker device;

FIG. 2 is a cross-sectional view showing a speaker device according to an embodiment of the invention;

FIG. 3 is an enlarged view of C portion in FIG. 2;

FIG. 4 is a perspective view showing a first damper in the embodiment of the invention;

FIG. 5 is a perspective view showing a second damper in the embodiment of the invention;

FIG. 6 is a view showing a connection of the first damper in the embodiment of the invention with a frame; and

FIG. 7 is a view showing a feeder structure of the second damper in the embodiment of the invention.

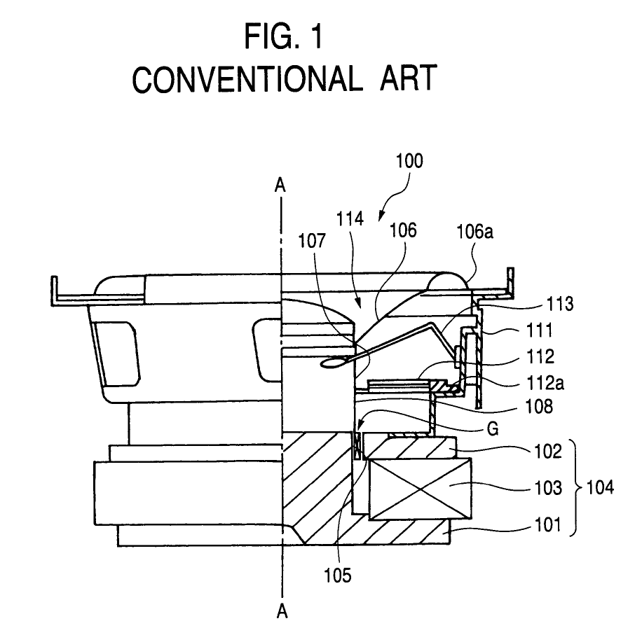

### DETAILED DESCRIPTION OF THE PREFERRED EMBODIMENTS

The preferred embodiments of the present invention will be described below with reference to the accompanying drawings.

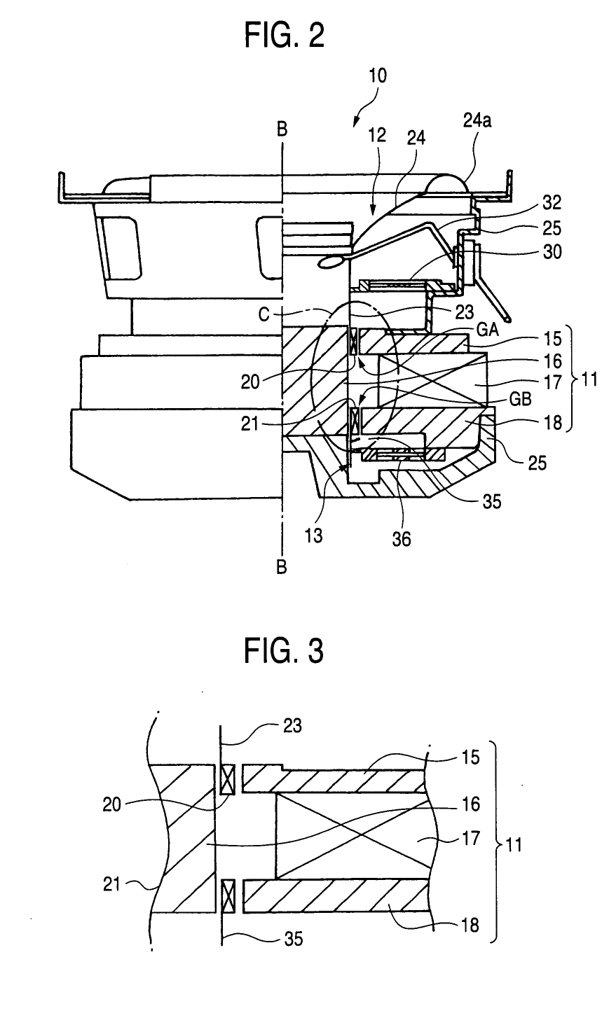

FIG. 2 is a view showing the structure of a speaker device according to an embodiment of the invention, its cross section being shown on the right side of the B-B line. FIG. 3 is an enlarged view showing a portion as indicated by C in FIG. 2.

The speaker device 10 according to the embodiment of the invention has a first vibration system 12 for radiating acoustic energy and a second vibration system 13 that is driven in a contrary direction to the first vibration system 12 by a magnetic circuit 11, as shown in FIG. 2.

Referring now to FIG. 3, a portion of the magnetic circuit 11 in the speaker apparatus 10 according to the embodiment of the invention will be described.

As shown in FIG. 3, the magnetic circuit 11 of the speaker device 10 is composed of a first plate 15, a yoke 16, a magnet and a second plate 18. And a first magnetic gap GA is formed between the first plate 15 and the yoke 16.

Also, a second magnetic gap GB is formed between the second plate 18 and the yoke 16. The magnet 17 is carried between the first plate 15 and the second plate 18.

As shown in FIG. 2, the first vibration system 12 of the speaker device 10 has a first voice coil 20 inserted in the first magnetic gap GA, in which the first voice coil 20 is connected to a diaphragm 24 and a frame 25. More specifically, an upper end portion of a first voice coil bobbin 23 of barrel shape having the first voice coil 20 wound is connected to the diaphragm 24, with an edge 24a of the diaphragm 24 being bonded with the frame 25.

Also, the first voice coil bobbin 23 is fitted with a first damper 30, in which an outer frame 41 of the first damper 30 is secured to the frame 25.

Also, the first voice coil 20 is soldered with a first gilt wire 32. Thereby, the first voice coil 20 is electrically connected to an input terminal (not shown) of the speaker device 10 via the first gilt wire 32 to supply an audio signal.

On the other hand, the second vibration system 13 has a second voice coil 21 inserted in the second magnetic gap GB, in which the second voice coil 21 is connected via a second damper 36 to the frame 25. More specifically, a second voice coil bobbin 35 of barrel shape having the second voice coil 21 wound is fitted with the second damper 36, and connected via the second damper 36 to the frame 25.

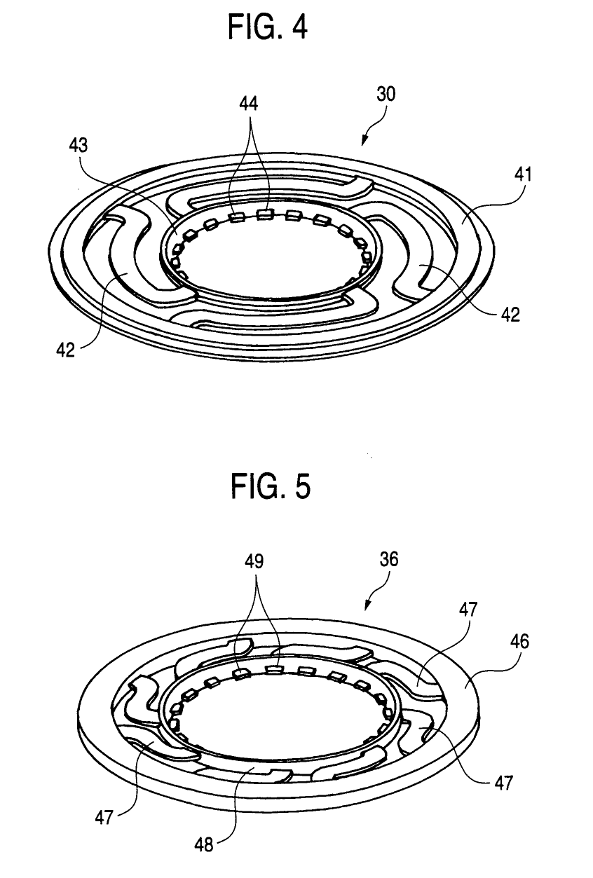

Referring to FIGS. 4 to 7, the first damper 30 provided to attenuate a vibration propagated from the first vibration system 12 to the frame 25 and the second damper 36 provided to attenuate a vibration propagated from the second vibration system 13 to the frame 25 will be described.

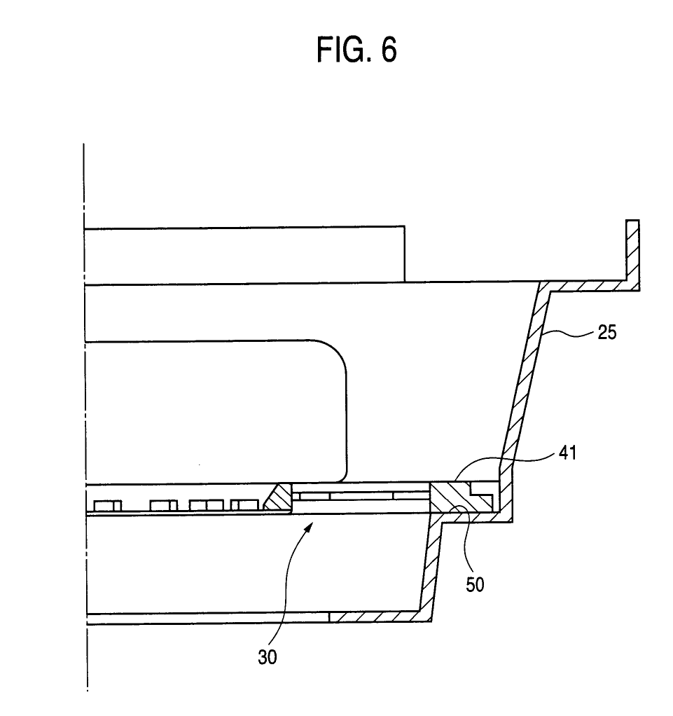

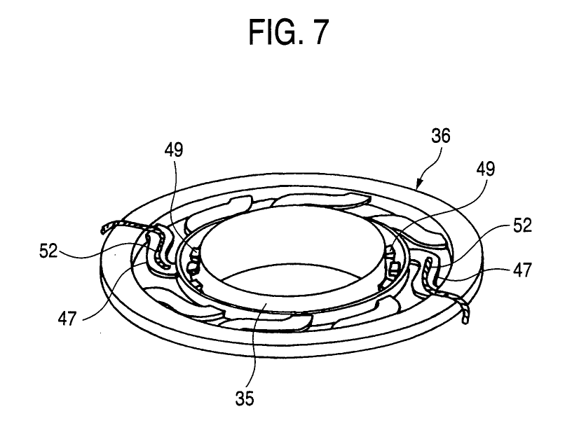

FIG. 4 is a perspective view showing the first damper 30, FIG. 5 is a perspective view showing the second damper 36, FIG. 6 is a view showing a connection between the first damper 30 and the frame, and FIG. 7 is a view showing a feeder structure of the second damper.

The first damper 30 is an exit butterfly damper, in which an inner frame 43 is connected via a resiliently deformable arm portion 42 to an outer frame 41, as shown in FIG. 4. Also, a plurality of projections 44 are formed on the inner periphery of the inner frame 43.

The plurality of projections 44 is held in contact with the outer periphery of the first voice coil bobbin 23 of barrel shape having the first voice coil 20 wound, and the outer frame 41 is secured to the frame 25. Thereby, the first voice coil 20 is secured via the first damper 30 to the frame 25.

The second damper 36 is an exit butterfly damper, in which an inner frame 48 is connected via a resiliently deformable arm portion 47 to an outer frame 46, as shown in FIG. 5. Also, a plurality of projections 49 are formed on the inner periphery of the inner frame 48.

The plurality of projections 49 is held in contact with the outer periphery of the second voice coil bobbin 35 of barrel shape having the second voice coil 21 wound, and the outer frame 46 is secured to the frame 25. Thereby, the second voice coil 21 is secured via the second damper 36 to the frame 25.

For the connection between the first damper 30 and the frame 25, the frame 25 has a step portion 30 formed on an inner peripheral surface in an almost central part thereof, as shown in FIG. 6. The outer frame 41 of the first damper 30 is fixed to this step portion 50, whereby the first damper 30 is held within the frame 25.

The second damper 36 is directly fixed to the second plate.

A second damper feeder structure is as shown in FIG. 7. In a state where the projections 49 of the second damper 36 are disposed on the outer periphery of the second voice coil 21, a second gilt wire 52 is crossed over the arm portion 47 and secured by a damping agent.

A top end of the second gilt wire 52 is electrically connected to the second voice coil 21 by soldering. Thereby, the second voice coil 21 is electrically connected to an input terminal of the speaker device 10 via the second gilt wire 52 to supply an audio signal.

That is, the audio signal supplied to the second voice coil 21 is the same as to the first voice coil 20.

The operation of the speaker device according to the embodiment of the invention will be described below.

In the first vibration system 12, an audio current supplied through the first gilt wire flows to the first voice coil 20, so that the first voice coil 20 is moved up and down to radiate an acoustic energy from the diaphragm. At this time, unnecessary vibration is propagated via the first plate 15 and the first damper 30 to the frame 25 as a reaction to an up and down movement of the first voice coil 20.

On the other hand, in the second vibration system 13, an audio current supplied through the second gilt wire flows to the second voice coil 21, so that the second voice coil 21 is moved up and down. At this time, a vibration in a contrary direction to the unnecessary vibration caused in the first vibration system 12 is propagated via the second plate 18 and the second damper 36 to the frame 25 as a reaction to an up and down movement of the second voice coil 21.

Hence, the unnecessary vibration caused in the first vibration system 12 and the opposite vibration produced in the second vibration system 12 cancel each other, so that the vibration of the frame is quite small. Thereby, it is possible to prevent vibration from being propagated to the housing to which the speaker device 10 is attached.

Also, the second vibration system 13 is driven by the same magnetic circuit as the first vibration system 12, and is constituted without providing a new magnetic circuit separately, by commonly using the yoke and the magnet, whereby a vibration suppressing mechanism of thin type is realized at a relatively low cost.

Also, the speaker device 10 is configured such that the first vibration system 12 and the second vibration system 13 are roughly equivalent in the easiness of movement, whereby the unnecessary vibration caused in the first vibration system 12 and the opposite vibration caused in the second vibration system have the almost same magnitude, canceling the unnecessary vibration more effectively.

Though in this embodiment the speaker device 10 of cone type has been described, this invention is also applicable to other speaker devices such as the dome type, as far as the speaker device employs the magnetic circuit.

Also, though the exit butterfly damper is employed as the first and second dampers 30 and 36 as shown in FIGS. 4 and 5, other dampers of the type usually employed in the speaker device may be employed.

As described above, the speaker device 10 of this embodiment has the first vibration system 12 that is driven by the magnetic circuit 12 and the second vibration system 13 that is driven in the contrary direction to the first vibration system 12 by the magnetic circuit 11, the first and second vibration systems 12 and 13 are moved in contrary directions to each other to cancel the unnecessary vibration and make the vibration of the frame 25 quite small.

With the above structure, the unnecessary vibration of the housing supporting the frame 25 is decreased, preventing the sound quality of the speaker device from being degraded because the housing itself resonates to generate a vibration sound, or a so-called beep at a joint or contact portion of the housing.

Moreover, in the speaker device built in the electronic apparatus such as a television or a personal computer, it is possible to prevent a malfunction or an operation failure from being caused due to unnecessary vibration of the electronic parts packaged in the electronic apparatus, which is propagated to the housing.

This invention is not limited to the above embodiment, but appropriate variations or modifications may be made thereto. Also, the magnetic circuit 11, the first vibration system 12, the second vibration system 13, the first plate 15, the yoke 16, the magnet 17, the second plate 18, the frame 25, the first damper and the second damper may be unlimitative in respect of the material, shape, size, form, number, disposition and thickness, as far as this invention is accomplished.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A speaker device comprising:
a magnetic circuit;
a first vibration system that is driven by the magnetic circuit; and
a second vibration system that is driven in a contrary direction to said first vibration system by the magnetic circuit.

2. The speaker device according to claim 1, wherein the magnetic circuit includes a first plate, a yoke, a magnet and a second plate,
wherein the first vibration system includes a first voice coil inserted in a first magnetic gap between the first plate and the yoke, with the first voice coil connected to a diaphragm and a frame, and
wherein the second vibration system includes a second voice coil inserted in a second magnetic gap between the second plate and the yoke, with the second voice coil connected via a damper to the frame.

3. The speaker device according to claim 2, wherein the easiness of movement of the first vibration system and the easiness of movement of the second vibration system are substantially equivalent to each other.
